(19) United States
(12) Patent Application Publication
(10) Pub. No.: US 2025/0164672 A1
(43) Pub. Date: May 22, 2025

(54) OPTICAL ELEMENT, METHOD FOR MANUFACTURING OPTICAL ELEMENT, AND OPTICAL EQUIPMENT

(71) Applicant: CANON KABUSHIKI KAISHA, Tokyo (JP)

(72) Inventors: YUKINOBU OKURA, Tokyo (JP); TOMOYUKI AOYAGI, Kanagawa (JP); YUKIMASA SUYAMA, Tokyo (JP)

(21) Appl. No.: 18/945,318

(22) Filed: Nov. 12, 2024

(30) Foreign Application Priority Data
Nov. 20, 2023 (JP) 2023-196930

(51) Int. Cl. G02B 5/08; G02B 5/10

(52) U.S. Cl. CPC G02B 5/0808; G02B 5/10

(57) ABSTRACT

An optical element includes: a substrate; and an optical shape layer that is formed on the substrate and that has a plurality of optical shape surfaces, wherein a thickness of the optical shape layer is 10 μm or larger and 3000 μm or smaller; and the optical element is provided with a groove, and a side surface of the optical shape layer and a side surface of the substrate along each contour of the plurality of optical shape surfaces form a side wall of the groove.

### BACKGROUND OF THE INVENTION

### Field of the Invention

The present technology relates to an optical element, a method for manufacturing an optical element, and optical equipment.

### Description of the Related Art

An optical element such as a mirror array is suitable for measuring light having a predetermined wavelength, for example, in an optical element for surface spectroscopy in a field of astronomical observation, etc. and a surface spectroscopic device using the optical element. In a surface spectroscopic device having a surface spectroscopic optical system, the optical element of the mirror array can be used in an image slicer type.

Surface spectroscopy is known as an observation method in the field of astronomical observation and enables simultaneous spectral observation of two-dimensional spatial information captured in a single exposure. One type of observation apparatus is an image slicer type, and examples of typical optical elements include a pupils mirror array and a slits mirror array.

In the observation in the field of astronomical observation, some cases, for example, where the optical element is placed in a severe natural environment such as outer space, a desert or a mountainous region, or where the optical element is placed in an extremely low temperature environment, in order to reduce the influence of thermal radiation of the optical element, which affects the observation, occurs. When a temperature difference between a manufacturing environment and a use environment of an optical element is large, such a degree of thermal deformation occurs in the optical element that maintenance of the shape accuracy is difficult, due to a difference in thermal expansion coefficient between materials constituting the optical element, and such a problem occurs that optical performance deteriorates.

In order to solve such a problem, Japanese Patent Application Laid-Open No. 2016-021057 discloses an optical element in which a plurality of optical function surfaces are formed on a single substrate by cutting work, an intermediate layer is provided between the substrate and a reflective layer, and the intermediate layer has a thermal expansion coefficient between those of a substrate and a reflective layer. Thereby, an optical element can be provided which can simultaneously achieve high-quality surface roughness while keeping a relative positional relationship among a plurality of optical function surfaces with high accuracy and can maintain shape accuracy even under a thermal influence of extreme environments.

### SUMMARY OF THE INVENTION

The present disclosure includes an optical element including: a substrate; and an optical shape layer that is formed on the substrate and that has a plurality of optical shape surfaces, wherein a thickness of the optical shape layer is 10 μm or larger and 3000 μm or smaller, and the optical element is provided with a groove, and a side surface of the optical shape layer and a side surface of the substrate along each contour of the plurality of optical shape surfaces form a side wall of the groove.

Further features of the present invention will become apparent from the following description of exemplary embodiments with reference to the attached drawings.

### BRIEF DESCRIPTION OF THE DRAWINGS

FIG. 1 illustrates a schematic view illustrating one example of a shape of an optical element of the present disclosure.

FIG. 2A illustrates a schematic view illustrating a cross section of one example of the shape of the optical element of the present disclosure.

FIG. 2B illustrates a schematic view illustrating a cross section of another one example of a shape of an optical element of the present disclosure.

FIG. 3A illustrates a schematic view illustrating atop surface of one example of a shape of an optical element of the present disclosure.

FIG. 3B illustrates a schematic view illustrating a top surface of another one example of a shape of an optical element of the present disclosure.

FIG. 4A illustrates a schematic view illustrating one example of a production process of an optical element of the present disclosure.

FIG. 4B illustrates a schematic view illustrating another one example of a production process of an optical element of the present disclosure.

FIG. 4C illustrates a schematic view illustrating another one example of a production process of the optical element of the present disclosure.

FIG. 4D illustrates a schematic view illustrating another one example of a production process of an optical element of the present disclosure.

FIG. 5 illustrates a schematic view illustrating optical equipment having a cooling function and including an optical element according to an embodiment of the present disclosure.

FIG. 6 illustrates a schematic view illustrating a cross section of an optical element of Comparative Example.

FIG. 7A illustrates a diagram illustrating a profile of a low-temperature deformation amount of the optical element of Examples.

FIG. 7B illustrates a diagram illustrating a profile of a low-temperature deformation amount of the optical element of Comparative Example.

### DESCRIPTION OF THE EMBODIMENTS

Preferred embodiments of the present invention will now be described in detail in accordance with the drawings.

In a case where a temperature difference between a manufacturing environment and a use environment of an optical element is large, it is necessary to maintain not only relative positions of the optical function surfaces but also a shape accuracy of each optical function surface, in order to prevent deterioration of the optical performance of the optical element for surface spectroscopy.

However, in the optical element described in Japanese Patent Application Laid-Open No. 2016-021057, a plurality of optical function surfaces are formed on a surface of a same optical shape layer, and accordingly shapes after thermal deformation are different from each other, depending on positions at which respective optical function surfaces are arranged.

In a case where an optical element is formed by cutting work, correcting work is performed in consideration of an amount of thermal deformation under a use environment. In this case, when the shape after thermal deformation differs depending on each optical function surface, it is conceivable to calculate a different correcting value for each optical function surface, but it takes a long time to form a plurality of optical function surfaces, and accordingly this case has been room for improvement.

In addition, even though a slit is provided between the optical function surfaces, shapes after thermal deformation are different from each other, depending on positions at which the respective optical function surfaces are arranged, because the optical function surfaces are formed on the surface of the same optical shape layer.

Accordingly, it is desired to simultaneously achieve suppression of thermal deformation of a whole optical element with high accuracy and suppression of a shape difference of a plurality of optical function surfaces, when each of the plurality of optical function surfaces has been thermally deformed.

The present disclosure has been made in view of the above circumstances, and an object thereof is to provide a highly accurate optical element.

Embodiments of an optical element according to the present disclosure will be described below, with reference to the drawings by taking an application to optical equipment as an example, but the application of the optical element according to the present embodiment is not limited to the optical equipment.

Embodiments and Examples described below are merely examples, and for example, a person skilled in the art can appropriately change and implement a detailed configuration in such a range as not to depart from a scope of the present disclosure.

In the drawings referred in the following description, elements denoted by same reference numerals shall have the same functions unless otherwise specified.

### First Embodiment

A first embodiment of the present disclosure relates to an optical element. An optical element of the present disclosure includes an optical element including: a substrate; and an optical shape layer that is formed on the substrate and that has a plurality of optical shape surfaces, wherein a thickness of the optical shape layer is 10 μm or larger and 3000 μm or smaller; and the optical element is provided with a groove, and a side surface of the optical shape layer and a side surface of the substrate along each contour of the plurality of optical shape surfaces form a side wall of the groove.

In addition, an optical element of the present disclosure includes an optical element including: a substrate; and an optical shape layer that is formed on the substrate and that has a plurality of optical shape surfaces, wherein an absolute value of a ratio of a thermal expansion coefficient of the optical shape layer to a thermal expansion coefficient of the substrate is 3.0 or larger; and the optical element is provided with a groove, and a side surface of the optical shape layer and a side surface of the substrate along each contour of the plurality of optical shape surfaces form a side wall of the groove.

In addition, an optical element of the present disclosure includes an optical element including: an opaque substrate; and an optical shape layer that is formed on the substrate and that has a plurality of optical shape surfaces, wherein a thermal expansion coefficient of the substrate is smaller than a thermal expansion coefficient of the optical shape layer; and the optical element is provided with a groove, and a side surface of the optical shape layer and a side surface of the substrate along each contour of the plurality of optical shape surfaces form a side wall of the groove.

An outline of the whole and each item will be described below.

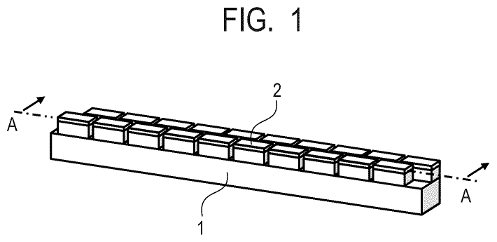

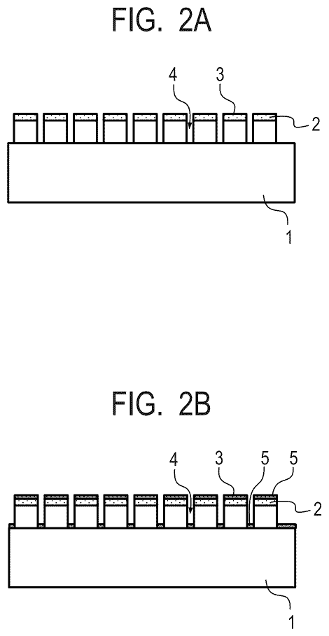

As an embodiment of the present disclosure, an optical element will be described which has a plurality of optical shape surfaces. FIG. 1 illustrates a view illustrating one example of a shape of the optical element. FIG. 2A and FIG. 2B illustrate views illustrating a cross section taken along the A-A line of FIG. 1. In FIG. 1, FIG. 2A and FIG. 2B, the optical element includes a substrate 1, an optical shape layer 2, an optical shape surface 3, a groove 4 and a reflective layer 5.

The optical element according to the present disclosure includes, as illustrated in FIG. 2A: a substrate 1; and an optical shape layer 2 that is formed on the substrate 1 and has a plurality of optical shape surfaces 3. On a surface of at least one layer of an optical shape layer 2 that has been laminated on the substrate 1 which becomes a base of the element, an optical shape surface 3 is arranged. The optical shape surface 3 is a flat surface or a curved surface and has a smooth mirror surface. In addition, a plurality of optical shape surfaces 3 are arrayed on the substrate 1, and a positional relationship between the plurality of optical shape surfaces and a surface shape are formed with high accuracy so as to exhibit desired optical characteristics.

### [Substrate]

A material of the above substrate is not limited, but in order to relax the above described problem of a deformation phenomenon due to the difference in thermal expansion coefficient between the substrate 1 and the optical shape layer 2, in a case where a temperature difference between the manufacturing environment and the use environment is large, a material is selected as the substrate 1, of which the thermal expansion coefficient is smaller than the thermal expansion coefficient of the optical shape layer 2. In addition, it is also acceptable to select a material which is generally called as a low thermal expansion material, in consideration of use under an extremely low temperature environment.

In the optical element of the present disclosure, the thermal expansion coefficient of the substrate 1 is smaller than the thermal expansion coefficient of the optical shape layer 2. In the optical element of the present disclosure, an absolute value of a ratio of the thermal expansion coefficient of the optical shape layer 2 to the thermal expansion coefficient of the substrate 1 is 3.0 or larger, is preferably 50 or larger, and is more preferably 500 or larger. Alternatively, in the optical element of the present disclosure, the thermal expansion coefficient of the substrate 1 is preferably 0.21 ppm/K or smaller, and is more preferably 0.05 ppm/K or smaller, from a viewpoint of suppressing thermal shrinkage of a whole optical element as much as possible. In the optical element of the present disclosure, it is preferable that the thermal expansion coefficient of the optical shape layer 2 is 10 ppm/K or larger. In the present disclosure, the thermal expansion coefficient refers to a linear expansion coefficient (thermal expansion coefficient) at a temperature at which the optical element is used. It is preferable that the temperature is room temperature, at which the optical element is manufactured, and it is preferable that the temperature is a liquid nitrogen temperature (77K), at which the optical element is used.

In this way, the optical element of the present disclosure can suppress thermal deformation of the optical element due to the difference in the thermal expansion coefficient between the substrate 1 and the optical shape layer 2, in a case where there is a large temperature difference between the manufacturing environment and the use environment. For information, the thermal expansion coefficient in the present disclosure can be obtained by, for example, a thermomechanical analysis.

In the optical element of the present disclosure, the substrate is opaque so that light to be observed is not reflected in the inside of the substrate. In the present disclosure, the term ‘opaque’ means that a light transmittance of a wavelength to be observed is less than 70%. Specifically, in the optical element of the present disclosure, it is preferable that the light transmittance of the substrate 1 is less than 70%, in the bands of visible light and infrared light. In the present disclosure, the light transmittance can be measured by, for example, a spectrophotometer.

In the optical element of the present disclosure, it is preferable that the substrate 1 contains one or more selected from the group, for example, consisting of pre-hardened steel, a low thermal expansion material, quartz and glass, and is more preferable that the substrate 1 is any of pre-hardened steel corresponding to SUS420J2, the low thermal expansion material, quartz and the glass. Specifically, STAVAX, BK7, Invar, ULE, Zerodur and Clearceram are included as candidate materials. In addition, alloys such as an iron alloy, a copper alloy, an aluminum alloy, a nickel alloy and a magnesium alloy are included as the substrate 1. In the optical element of the present disclosure, it is preferable that the substrate 1 contains an alloy. The alloy constituting the substrate 1 can be selected according to the required conditions such as low thermal expansion, heat resistance, workability, corrosion resistance, lightness, rigidity and economy. According to the present embodiment, deformation of the optical element can be suppressed by a groove 4 being provided. From a viewpoint of a low thermal expansion, it is more preferable that the substrate 1 contains Invar. In this way, deformation of the substrate 1 due to thermal expansion or thermal contraction can be suppressed, even in a temperature environment which is different from that in manufacturing.

In the optical element of the present disclosure, it is preferable that a thickness of a portion of the substrate which overlaps a groove (thickness measured from a bottom face of the substrate to a bottom face of the groove) is 30 mm or larger and 60 mm or smaller. In the present disclosure, a thickness, a film thickness and a size can be measured, for example, by photographing with a camera for dimension measurement and image analysis, and optical microscope observation or scanning electron microscope (SEM) observation of a cross section, etc.

### [Optical Shape Layer]

As a material to be used for the above optical shape layer 2, it is preferable to select a material which can be easily worked into an optical functional shape. In particular, it becomes important to form a relative positional relationship between a plurality of optical shape surfaces 3 with high accuracy, and to form a smooth mirror surface so that light to be observed is not scattered more than necessary, in terms of a function of the optical element for surface spectroscopy. Because of this, it is desirable to select a material excellent in specularity in the cutting work using a diamond tool.

In the optical element of the present disclosure, it is preferable that the optical shape layer 2 is a film containing Cu or Ni as a main component and is more preferable that the optical shape layer 2 is, for example, a plating film which is excellent in specularity and contains Cu or Ni as a main component. In order to relax the deformation phenomenon due to the difference in the thermal expansion coefficient between the substrate 1 and the optical shape layer 2, it is preferable to select a material of which the difference in the thermal expansion coefficient is small between the substrate 1 and the optical shape layer 2. In addition, the optical shape layer 2 may be formed of a plurality of laminated materials. In this case, it is preferable that a material of a layer which directly comes in contact with the substrate 1 among the plurality of materials has the smallest difference in the thermal expansion coefficient from the substrate 1.

It is particularly preferable for a thickness of the optical shape layer 2 to be 300 μm, for example, in order to suppress peeling and cracking of the optical shape surface due to thermal influence even under an extreme environment, and to be precisely cutting-worked. In the optical element of the present disclosure, a thickness of the optical shape layer 2 is 10 μm or larger and 3000 μm or smaller.

A lower limit of the film thickness of the optical shape layer 2 may be approximately a numerical value that secures a working error in the cutting work and a constant removal amount, and is preferably about 10 μm. Furthermore, it is acceptable for an upper limit of the film thickness of the optical shape layer 2 to be such a value as to be capable of forming a dense plating film for forming a smooth mirror surface, and is preferable to be about 3000 μm, also from a viewpoint of suppressing an increase in an internal stress of a plating film.

### [Optical Shape Surface]

In the optical element of the present disclosure, it is preferable that the optical shape layer 2 has a plurality of optical shape surfaces 3, and that the optical shape surface 3 is provided on a surface of at least one optical shape layer 2 laminated on the substrate 1. The optical shape surface 3 has a shape of being flat or being curved surface and has a smooth mirror surface. In addition, a plurality of optical shape surfaces 3 are arrayed on the substrate 1, and the positional relationship between a plurality of optical shape surfaces 3 and a surface shape is formed with high accuracy, so as to exhibit desired optical characteristics (for example, so as to guide light reflected by an optical element to a desired direction).

When the optical element does not have a reflective layer 5 which will be described later, on the optical shape surface 3, the optical shape surface 3 plays a role of reflecting light. In the optical element of the present disclosure, it is preferable that an area of one optical shape surface of the plurality of optical shape surfaces 3 is 1 mm² or larger and 625 mm² or smaller.

### [Groove]

The optical element of the present disclosure is provided with a groove 4, and a side surface of the optical shape layer 2 and a side surface of the substrate along each contour of the plurality of optical shape surfaces 3 form a side wall of the groove 4. The size of the above groove 4 is not limited, but the width of the groove 4 needs to be small to such an extent that the effective area of the optical shape surface 3 is not impaired. It is preferable that the depth of the groove 4 is sufficiently deep to suppress a decrease in the optical performance due to the deformation phenomenon caused by the difference in the thermal expansion coefficient between the substrate 1 and the optical shape layer 2. It is acceptable for a shape of the groove 4 to be a tapered shape which widens from the optical shape surface 3 toward the substrate 1, or to be also a V groove which narrows from the optical shape surface 3 toward the substrate 1.

In the optical element of the present disclosure, it is preferable that the substrate 1 and the optical shape layer 2 have the groove 4 along each contour of the optical shape surfaces 3 so that a side surface of the substrate 1 and a side surface of the optical shape layer 2 form one surface (continuous surface). It is acceptable for the continuous surface to be such a surface that a substrate surface and an optical shape layer surface are directly continuous, or that a side surface of an intermediate layer lies between the substrate 1 and the optical shape layer 2.

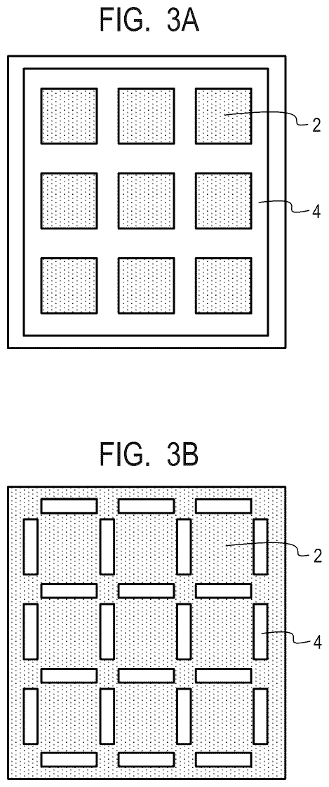

In FIG. 3A and FIG. 3B, top views are illustrated which illustrate schematically one example of shapes of optical elements of the present disclosure. Here, FIG. 3A and FIG. 3B are each one example of top views of FIG. 1 or FIG. 2A. The grooves 4 may be arranged so as to separate the optical shape layers 2 from each other, as illustrated in FIG. 3A, and the grooves 4 may be arranged so that a part of the optical shape layer 2 is separated and another part is continuous, as illustrated in FIG. 3B. An arrangement pattern of the optical shape layer 2 is not limited to the arrangement pattern as illustrated in FIG. 3A and FIG. 3B; and may be a staggered pattern as illustrated in FIG. 1 and may be any pattern.

A numerical range of a width of the groove 4 may be any numerical value as long as the groove 4 can be machined, and it is preferable for the width of the groove 4 in the optical element of the present disclosure to be 0.02 mm or wider and 3 mm or narrower. In the optical element of the present disclosure, it is preferable that a depth of the groove 4 is 5 mm or larger and 20 mm or smaller in order to suppress a decrease in the optical performance due to the deformation phenomenon caused by the difference in the thermal expansion coefficient between the substrate 1 and the optical shape layer 2.

In order to relax the deformation phenomenon due to the difference in the thermal expansion coefficient between the substrate 1 and the reflective layer 5 which will be described later, it is preferable that on at least a part of the side surface of the groove 4, the substrate 1 is exposed.

### [Reflective Layer]

It is preferable for the optical element of the present disclosure to include a reflective layer provided on the optical shape surface, as illustrated in FIG. 2B, and is preferable to include the reflective layer 5 on the optical shape surface 3 and the bottom face of the groove 4 according to the wavelength of a light beam which is used for an observation. A side wall of the groove 4 may be covered with the reflective layer 5, etc. As a material to be used for the reflective layer, a material is selected which can reflect the wavelength of light to be observed and can obtain a constant reflection efficiency. In particular, a metal material suitable for vapor deposition which is easy to form as a thin film may be selected in order to have a reflection function without destroying a shape of the optical shape surface 3. In the optical element of the present disclosure, it is preferable that a thickness of the reflective layer 5 is smaller than a thickness of the optical shape layer 2.

In the optical element of the present disclosure, it is preferable that a material of the reflective layer 5 is attached to the substrate 1 in the groove 4. In the optical element of the present disclosure, it is preferable that the reflective layer 5 is a layer containing one selected from the group consisting of Au, Ag and Al as a main component, and the reflective layer 5 is a metal film that contains any of Au, Ag and Al which have excellent reflection characteristics in the visible light region, as a main component. In addition, it is also acceptable for the reflective layer 5 to be a layer in which dielectric multilayer films are laminated.

### [Others]

The optical element of the present disclosure is not limited to a case where the optical element has the above described size but is also effective when the optical element has such a ratio as in the followings. It is preferable that a ratio of the total area of the grooves 4 in a top view of the optical element to a total area of the optical shape surfaces 3 is 0.04 or larger and 5 or smaller. It is preferable that a ratio of the depth of the groove 4 to a thickness of the optical shape layer 2 is 1.6 or larger and 1000 or smaller. It is preferable that a ratio of the thickness of the portion of the substrate 1 which overlaps the groove 4 to the thickness of the optical shape layer 2 is 10 or larger and 3000 or smaller. It is preferable that a ratio of a width of the groove 4 to a depth of the groove 4 is 0.001 or larger and 0.6 or smaller. By doing this, it is possible to simultaneously achieve suppression of the thermal deformation of a whole optical element, and the suppression of a difference in the shape between a plurality of optical shape surfaces 3 at the time when each of the plurality of optical shape surfaces 3 has been thermally deformed.

### Second Embodiment

A second embodiment of the present disclosure relates to a method for manufacturing the optical element.

The method for manufacturing the optical element of the present disclosure includes: a film forming step of forming the film on a substrate; a groove forming step of forming a groove by working the substrate and the film; and an optical shape surface forming step of forming the optical shape surface by working the film.

Each step of the method for manufacturing the optical element will be described below. It is preferable to conduct the method for manufacturing the optical element, in an order of a preparation step, the film forming step, the groove forming step, and the optical shape surface forming step. Each item of the optical element is similar to those described above, and accordingly, the description is omitted in some cases.

### [Preparation Step]

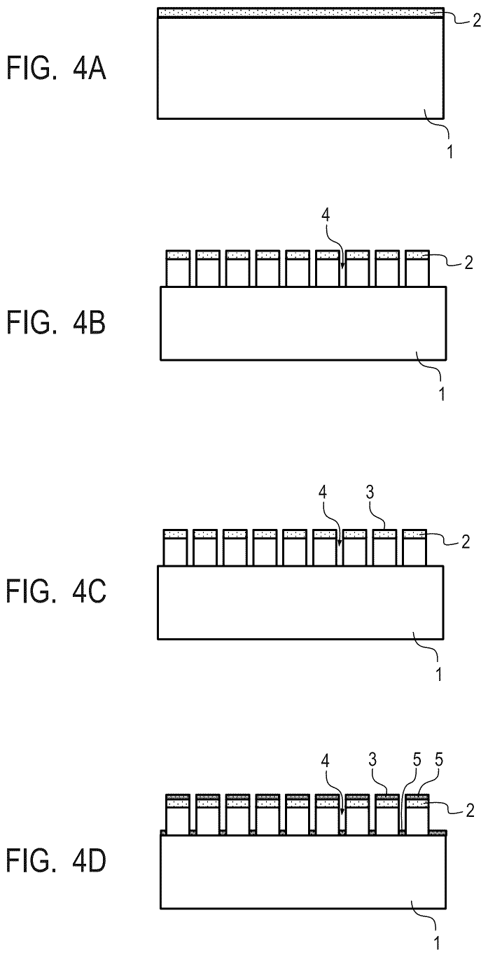

It is preferable that the method for manufacturing the optical element of the present disclosure includes a preparation step of preparing the substrate 1. FIG. 4A to FIG. 4D are schematic views illustrating a manufacturing process of the optical element. Firstly, as illustrated in FIG. 4A, as the substrate 1, for example, an Invar material is selected which has a thermal expansion coefficient of 0.03 ppm even in an environment of −196° C., and a rectangular parallelepiped of, for example, 15 mm×270 mm×58 mm is cut out from the bulk material. It is desirable to preliminarily work the flatness and orthogonality of at least a portion (for example, a corner portion) which becomes an installation reference when the optical element is worked, with high accuracy.

It is acceptable to additionally work an upper portion of the rectangular parallelepiped so as to have a shape along the optical shape surface 3, in consideration of the positional relationship from the previously described installation reference, as a foundation for forming the optical shape surface 3 in a surface spectroscopic optical system which has been designed and arranged so as to obtain desired optical characteristics.

### [Film Forming Step]

The method for manufacturing the optical element of the present disclosure includes the film forming step of forming a film on the substrate 1. In the film forming step, films are laminated for forming a plurality of optical shape surfaces. In particular, as a material excellent in mirror finish workability, copper sulfate plating, for example, is selected. The copper sulfate plating forms an electrolytic plating film containing copper as a main component and forms a dense layered film by a wet process.

A thickness of the film is, for example, 300 μm, in order to suppress peeling and cracking of the optical shape surface due to the thermal influence even under an extreme environment, and to be precisely cutting-worked. However, the thickness is not limited to the value and may be 10 μm or larger and 3000 μm or smaller.

A lower limit of the film thickness of the film may be approximately a numerical value that secures a working error in the cutting work and a constant removal amount, and is preferably about 10 μm. Furthermore, it is acceptable for an upper limit of the film thickness of the film to be such a value as to be capable of forming a dense plating film for forming a smooth mirror surface, and is preferable to be about 3000 μm, also from a viewpoint of suppressing an increase in an internal stress of a plating film.

### [Groove Forming Step]

A method for manufacturing the optical element of the present disclosure includes a groove forming step of working the substrate 1 and the film to form the groove 4. In the groove forming step, as illustrated in FIG. 4B, the groove 4 is formed by machining in order to enable to simultaneously achieve a suppression of thermal deformation of a whole optical element and a suppression of shape differences among each of a plurality of optical shape surfaces 3 after the thermal deformation.

A width of the groove 4 may be in a numerical range in which machining is possible, and it is preferable to be 0.02 mm or wider and 3 mm or narrower. It is preferable that a depth of the groove is 5 mm or larger and 20 mm or smaller, in order to suppress a decrease in the optical performance due to the deformation phenomenon caused by a difference in the thermal expansion coefficient between the substrate 1 and the optical shape layer 2.

In the method for manufacturing the optical element of the present disclosure, it is preferable that the groove forming step includes machining as a method for forming the groove, and it is preferable to include end milling, wire cutting or fine cutting, for example. For example, a groove having a width of 1 mm and a depth of 7.5 mm is formed in an optical shape surface of 13 mm×7 mm, by end milling. The method of forming the groove is not limited to machining, but, for example, wet etching, dry etching, etc. may be used.

### [Optical Shape Surface Forming Step]

The method for manufacturing the optical element of the present disclosure includes an optical shape surface forming step of working the film to form the optical shape surface 3. In a method for manufacturing an optical element of the present disclosure, it is preferable to conduct the optical shape surface forming step after the groove forming step. In the optical shape surface forming step, as illustrated in FIG. 4C, the optical shape surface 3 having a curved surface is formed by removing the film by precision cutting work using, for example, a diamond tool having a curved portion on a cutting edge, while considering the positional relationship with respect to the above described installation reference.

In the precision cutting work, it is necessary to form a smooth mirror surface of about 1 nm by RMS so that light to be observed is not scattered more than necessary, and as a machining condition at this time, it is preferable to control a removal thickness as thin as possible. For example, a curved portion of a tool is set to be R of 20 mm, and a target cusp height is set to be PV of 2 nm or smaller.

### [Reflective Layer Forming Step]

It is preferable that the method for manufacturing the optical element of the present disclosure includes a reflective layer forming step of forming the reflective layer 5 on the optical shape surface 3. In the reflective layer forming step, as illustrated in FIG. 4D, the reflective layer 5 containing, for example, gold is formed which has excellent reflection characteristics in the visible light region.

The reflective layer 5 needs to be a thin film having a constant thickness so as not to deform a shape of the optical shape surface 3 formed on the optical shape layer 2 as much as possible, and accordingly, is preferably formed by sputtering, but is not limited thereto. Various manufacturing methods which are generally called a dry process, such as a physical vapor deposition method and a chemical vapor deposition method may be used, as long as the method is a process capable of forming a thin film having a constant film thickness from a predetermined material. A film of, for example, 40 nm is formed as the reflective layer 5, in consideration of film thickness stability of a coating film and reflectivity of light to be observed.

### Application Example

An application example of the present disclosure relates to optical equipment.

It is preferable that the optical equipment of the present disclosure includes the optical element described above.

In addition, it is preferable that the optical equipment of the present disclosure includes the optical element described above, and a cooling device which cools the optical element described above to below freezing.

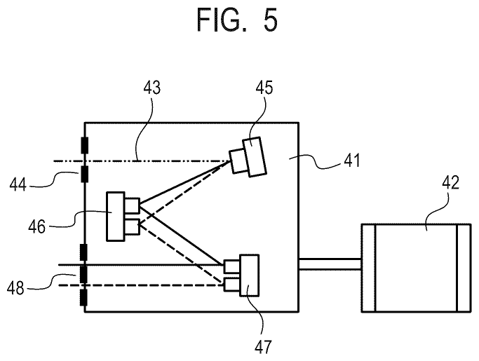

The optical equipment will be described which includes the optical element of the present embodiment and has a cooling function. FIG. 5 illustrates a schematic view illustrating the optical equipment which includes the optical element according to the embodiment of the present disclosure and has a cooling function. In FIG. 5, the optical equipment is a surface spectroscopic device 41, a cooling device 42, a light beam 43, an incident slit 44, a slicer mirror 45, a planar mirror array 46, a curved mirror array 47, and an exit slit 48. The optical element of the present disclosure is applicable to the planar mirror array 46 and the curved mirror array 47.

A configuration of the optical equipment in the present embodiment is one example; and as long as the configuration includes, for example, the optical element having a plurality of optical shape surfaces, which is described in claim 1, other configurations are not limited, and various components may be combined.

In FIG. 5, the cooling device 42 is connected to the surface spectroscopic device 41, and an inside of the surface spectroscopic device 41 can be cooled by the cooling device 42. The light beam 43 passes through the incident slit 44 that faces the surface spectroscopic device 41 which has been cooled by the cooling device 42; is spectrally dispersed into a plurality of light beams by a slicer mirror 45 which can spectrally disperse the light beam; each of spectrally dispersed light beams is reflected by each of the optical shape surfaces of a planar mirror array 46 for reducing the size of the optical equipment; and the light beam is bent. The reflected light beam is condensed and reflected by each of the optical shape surfaces of the curved mirror array 47 having a condensing function, passes through the exit slit 48, and is guided to a light receiver which is not illustrated.

As factors for determining a performance of the optical equipment according to the present embodiment, it is necessary to simultaneously achieve high-quality surface roughness while keeping the relative positional relationship between a plurality of optical shape surfaces of a diffractive optical element with high accuracy; and to spectrally disperse the light beam to a desired position by maintaining a shape accuracy even under a thermal influence of an extreme environment. Optical equipment having excellent environmental resistance can be provided by the optical equipment which includes the optical element according to the embodiment of the present disclosure and is provided with the cooling function.

The highly accurate optical element is not limited to astronomical application but may be used for various purposes such as consumer application and industrial application. In addition, the optical element is not limited to be applied to the optical equipment but may be applied to a light condensing device, a reflection device, etc., or may be used for a reduction optical system, an enlargement optical system or a correction optical system.

### EXAMPLE

In this Comparative Example, the optical element will be described that is provided with an optical shape layer having a plurality of optical shape surfaces formed on a conventional substrate, to which the present disclosure is not applied.

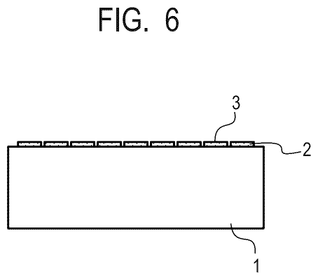

FIG. 6 illustrates a schematic view illustrating a cross section of an optical element of Comparative Example (conventional example). In FIG. 6, the optical element has a substrate 1, an optical shape layer 2, and an optical shape surface 3. As illustrated in FIG. 6, in the conventional optical element, a plurality of optical shape surfaces 3 are formed on the surface of a same optical shape layer 2 on the substrate 1.

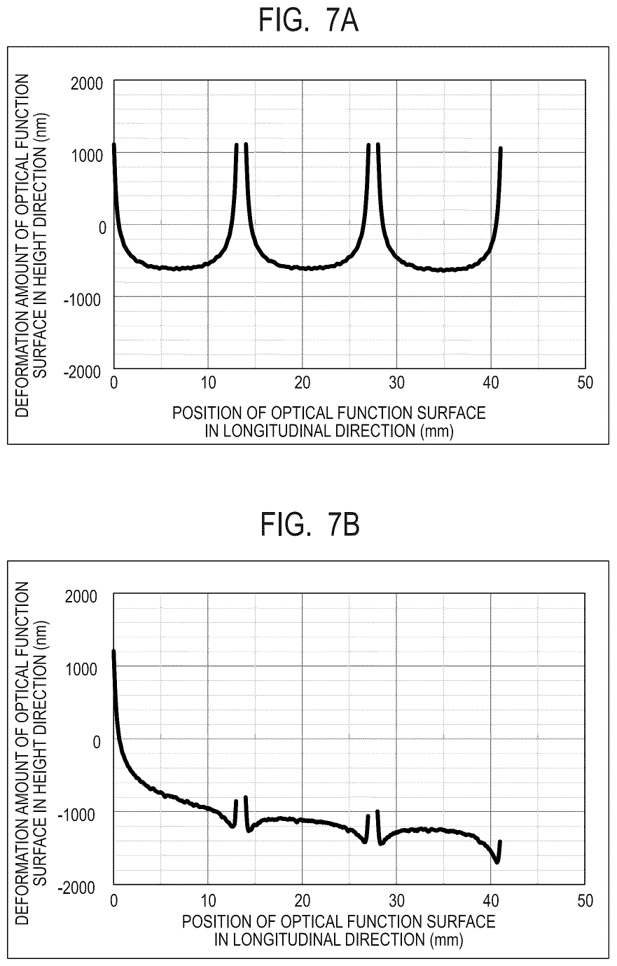

FIG. 7A and FIG. 7B are graphs which compare the shapes after thermal deformation of the optical elements according to the embodiment of the present disclosure (optical element of Example) and the optical element of Comparative Example. FIG. 7A illustrates the shape after thermal deformation of the optical element of Example, and FIG. 7B illustrates the shape of the optical element of Comparative Example.

In the optical elements of Example and the optical element of Comparative Example, a height of the substrate was set to 57.5 mm, a size of the optical shape surface was set to 13 mm×7 mm, and a space between the optical shape surfaces was set to 1 mm; and the number of optical shape surfaces was set to 3 surfaces×2 rows, the thicknesses of the optical shape layer was set to 0.05 mm, and the optical shape surfaces were set to be flat surfaces. An amount of temperature change between in manufacturing and in using the optical element (value obtained by subtracting the temperature in manufacturing the optical element from the temperature in using the optical element) was set to −219 K (the temperature in manufacturing the optical element was room temperature (296 K(+23° C.)), and the temperature in using the optical element was set to a temperature of liquid nitrogen (77 K)).

Furthermore, in the optical element of Example and the optical element of Comparative Example, the substrate was an Invar material (IC-DX) having a thermal expansion coefficient of −0.03 ppm/K, and the optical shape layer was a Cu layer which had a thermal expansion coefficient of 17.7 ppm/K and was produced by Cu sulfate plating treatment. In the optical element of Example, a depth of the groove was set to 7.5 mm, and a width of the groove was set to 1 mm. In the optical element of Comparative Example, the groove was not produced. Under the above conditions, the shapes of the outer edges of the optical shape surfaces of 3 surfaces×1 row were compared after the thermal deformation.

As a result of comparison, as for the shape of the optical element of Example after the thermal deformation illustrated in FIG. 7A, the difference is small among each of the optical shape surfaces. On the other hand, as for a shape of the optical element of Comparative Example after the thermal deformation illustrated in FIG. 7B, shapes of the optical shape surfaces are different from each other, and the difference is large.

From this result, the present disclosure is to simultaneously achieve suppression of the thermal deformation of the whole optical element and suppression of the thermal deformation of each of the plurality of optical shape surfaces, by providing a groove along a contour of each optical shape surface so that the side surface of the substrate and the side surface of the optical shape layer form one surface, because the island-shaped protruding portions are thereby independently deformed which are each formed of the substrate and the optical shape layer.

According to the present disclosure, a highly accurate optical element can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-196930, filed Nov. 20, 2023, which is hereby incorporated by reference herein in its entirety.

What is claimed is:

1. An optical element comprising:
a substrate; and
an optical shape layer that is formed on the substrate and that has a plurality of optical shape surfaces, wherein
a thickness of the optical shape layer is 10 μm or larger and 3000 μm or smaller, and
the optical element is provided with a groove, and a side surface of the optical shape layer and a side surface of the substrate along each contour of the plurality of optical shape surfaces form a side wall of the groove.

2. An optical element comprising:
a substrate; and
an optical shape layer that is formed on the substrate and that has a plurality of optical shape surfaces, wherein
an absolute value of a ratio of a thermal expansion coefficient of the optical shape layer to a thermal expansion coefficient of the substrate is 3.0 or larger, and
the optical element is provided with a groove, and a side surface of the optical shape layer and a side surface of the substrate along each contour of the plurality of optical shape surfaces form a side wall of the groove.

3. An optical element comprising:
an opaque substrate; and
an optical shape layer that is formed on the substrate and that has a plurality of optical shape surfaces, wherein
a thermal expansion coefficient of the substrate is smaller than a thermal expansion coefficient of the optical shape layer, and
the optical element is provided with a groove, and a side surface of the optical shape layer and a side surface of the substrate along each contour of the plurality of optical shape surfaces form a side wall of the groove.

4. The optical element according to claim 1, further comprising a reflective layer provided on the optical shape surface.

5. The optical element according to claim 4, wherein a material of the reflective layer is attached to the substrate in the groove.

6. The optical element according to claim 4, wherein the reflective layer is a layer containing one selected from the group consisting of Au, Ag and Al, as a main component.

7. The optical element according to claim 1, wherein a thermal expansion coefficient of the substrate is 0.21 ppm/K or smaller.

8. The optical element according to claim 1, wherein a thermal expansion coefficient of the optical shape layer is 10 ppm/K or larger.

9. The optical element according to claim 1, wherein a width of the groove is 0.02 mm or larger and 3 mm or smaller.

10. The optical element according to claim 1, wherein a depth of the groove is 5 mm or larger and 20 mm or smaller.

11. The optical element according to claim 1, wherein a thickness of a portion of the substrate which overlaps the groove is 30 mm or larger and 60 mm or smaller.

12. The optical element according to claim 1, wherein an area of one optical shape surface of the plurality of optical shape surfaces is 1 mm² or larger and 625 mm² or smaller.

13. The optical element according to claim 1, wherein a ratio of a total area of the grooves in a top view of the optical element to a total area of the optical shape surfaces is 0.04 or larger and 5 or smaller.

14. The optical element according to claim 1, wherein a ratio of a depth of the groove to a thickness of the optical shape layer is 1.6 or larger and 1000 or smaller.

15. The optical element according to claim 1, wherein a ratio of a thickness of a portion of the substrate which overlaps the groove to a thickness of the optical shape layer is 10 or larger and 3000 or smaller.

16. The optical element according to claim 1, wherein the substrate has a light transmittance of less than 70% in bands of visible light and infrared light.

17. The optical element according to claim 1, wherein the substrate contains an alloy.

18. The optical element according to claim 1, wherein the optical shape layer is a layer containing Cu or Ni as a main component.

19. A method for manufacturing an optical element, comprising:
forming a film on a substrate;
forming a groove by working the substrate and the film; and
forming an optical shape surface by working the film.
